(19) United States
(12) Patent Application Publication
(10) Pub. No.: US 2011/0071950 A1
(43) Pub. Date: Mar. 24, 2011

(54) CUSTOMER-ORIENTED CUSTOMER RELATIONSHIP MANAGEMENT PROCESS AND SYSTEM

(75) Inventor: Aleksandar Ivanovic, Milwaukee, WI (US)

(73) Assignee: Webcom, Inc., Milwaukee, WI (US)

(21) Appl. No.: 12/887,905

(22) Filed: Sep. 22, 2010

Related U.S. Application Data
(60) Provisional application No. 61/245,021, filed on Sep. 23, 2009.

(51) Int. Cl. G06Q 10/00

(52) U.S. Cl. 705/304

(57) ABSTRACT

A method and system for customer service and support integrated with social networks includes an Internet available server application where consumers and providers can create their profiles, integrate their profiles with existing social network profiles, and collaborate with each other on resolving consumer issues using a workflow engine supported with a rule engine. Consumers may be organized into consumer groups and into federations of consumer groups. Consumer issues may be voted on thereby raising the significance of an issue and/or building a provider's reputation based in part on resolved issues, issue votes, and by reviews and comments. Consumers manage their profiles. Provider profiles are predominately affected by resolved/unresolved issues or positive/negative reviews. Notifications are handled automatically based on configured workflow and rule engine and utilize internal messaging system, emails, SMS and other available social network services (e.g. Facebook, Twitter, etc.).

### CROSS-REFERENCE TO RELATED APPLICATIONS

This application claims priority to U.S. provisional application Ser. No. 61/245,021, filed Sep. 23, 2009, the entire contents of which is incorporated herein by reference.

### FIELD OF THE INVENTION

The subject matter disclosed herein relates generally to a method and system for providing customer service and support integrated with social networks. More specifically, the subject matter discloses a consumer driven customer service network to encourage improved responsiveness and resolutions from providers.

### BACKGROUND OF THE INVENTION

Historically, customer relationship systems have been managed by the provider with which the consumer has an issue. The issue may, for example, describe a dispute between the consumer and the provider or may also describe a service request, a warranty repair request, a billing clarification request, or any other request for information from the provider by the consumer. Typically, a provider is notified of an issue by the consumer placing a phone call or sending an email or an instant message to a customer service department. A customer service representative responds to the consumer either during a real time voice or electronic discussion or via return email. The customer service representative may then file an internal report or record the issue on the provider's internal Customer Relationship Management (CRM) system. At this point, the provider must decide whether and how to respond further to the customer's issue. The provider may or may not have resolved the issue to the satisfaction of the consumer by this time. All of the data relating to the management and handling of the issue remains controlled by the provider. Consequently, the general public is often unaware of service or quality concerns with a specific provider.

These internal CRM systems often put the consumer at a disadvantage. The provider controls the scope and content of the information entered into the CRM and also controls who has access to the information. The choice of whether, how, and to what extent to address the issue rests solely with the provider. As such, the provider may close the case without reaching a resolution that is acceptable to the consumer. Because the provider controls access to the CRM and the scope and content information within the CRM, such actions may be taken with little risk of another customer becoming aware of an unsatisfactory resolution.

Thus, it would be beneficial to provide a universal system for consumers to provide feedback and resolve issues with providers. The improved CRM system would provide enhanced control of the dispute resolution process by the consumer and also provide incentives for providers to resolve disputes quickly and fairly. It would also permit the consumer to easily communicate information about his or her experience with other interested individuals.

### SUMMARY OF THE INVENTION

Consistent with the foregoing and in accordance with the subject matter as embodied and broadly described herein, a consumer-driven customer service network that encourages improved responsiveness and resolutions from providers is described in suitable detail to enable one of ordinary skill in the art to make and use the invention.

In one embodiment of the invention, a network-based customer relationship system for managing data exchanged between a plurality of consumers and a plurality of providers includes a consumer interface configured to receive data from at least one of the consumers, the data including a field to identify one of the providers, and an application module in communication with the consumer interface and executable on a processor to establish a case corresponding to the data entered by the consumer, extract the field identifying the provider, and notify the provider of the existence of the case. The case is accessible to at least one other consumer who accesses the application module via the consumer interface.

According to another aspect of the invention, the application module is further executable to communicate on a network to establish an interactive environment accessible by the consumers and the providers and to access a data storage device on which each of the consumers and providers establishes an account for the interactive environment. The account preferably requires user verification to access.

The network-based customer relationship system may also include an Application Programming Interface (API) configured to interface with another network-based environment. The account of the consumers or providers for the interactive environment may include information about a respective account for the consumer or provider on the other network-based environment, and the API may use the information to permit access to the interactive environment from the other network-based environment without additional user verification. Thus, it is a feature of this invention that the interactive environment of the customer relationship system is easily accessible from other social networking environments.

As another aspect of the invention, the application module is further executable to establish a plurality of groups of which one or more consumers or providers are members. The groups may be established according to the content of the cases, and the application module may be configured to notify each member of the group when a new case is established which contains the respective content.

As still another aspect of the invention, the application module may be configured to manage a scoring system ranking each of the providers as a function of the number of cases in which that provider is identified. The provider may respond to any of these cases regardless of whether the provider is identified and the ranking of each of the providers is a function of the response. Thus, it is a feature of the present invention to provide a scoring system for providers which ranks the provider according to both the number of cases established by consumers and the responsiveness of the provider.

According to another embodiment of the invention, a method of managing a customer relationship system includes executing at least one application module on a server to provide an interactive environment for a plurality of consumers and providers to provide information to each other. The information, which relates to at least one provider, is received through a consumer interface. A case corresponding to the information received from each consumer is created, and the case and the related information are stored in a database on a physical storage medium connected to the server. Each provider identified in the case is notified that the case has been established, and the case is made available to a plurality of other consumers, on-line or via another access channel.

The method of managing the customer relationship system may further include receiving a response from each provider relating to the case through a provider interface and storing the response from the provider in the database on the physical storage medium connected to the server. The consumer is notified of the response, and the response is also made available to the plurality of other consumers. The case may be resolved by one of the following steps: closing the case by the consumer, closing the case at a predefined time interval after receiving the response from the provider, or closing the case in response to other consumers' voting on the acceptability of the response from the provider. The provider may be rated according to at least one of a time required for response, a total number of cases reported to the provider, and a level of consumer satisfaction with the responses received from the provider.

As still another aspect of the invention, a plurality of groups of consumers may have been established within the customer relationship system, and at least one the groups is notified of the new case according to the information relating to the case. Additionally, feedback may be requested from the consumers belonging to the group notified of the new case.

These and other objects, advantages, and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiment.

In the drawings:

FIG. 1 is a block diagram representation of a customer relationship management system according to an embodiment of the present invention;

FIG. 2 is a representation of an exemplary environment incorporating one embodiment of the present invention;

FIG. 3 is a block diagram representation of a module structure according to an embodiment of the present invention;

FIG. 4 is a block diagram representation of a database structure according to an embodiment of the present invention;

FIG. 5 is a flowchart illustrating the process for posting consumer reviews according to an embodiment of the present invention;

FIG. 6 is a flowchart illustrating the process for resolving a consumer issue according to an embodiment of the present invention;

FIG. 7 is a flowchart illustrating the process for consumer interaction with other consumers according to an embodiment of the present invention;

FIG. 8 is a flowchart illustrating the process for a provider managing the issues assigned to the provider according to an embodiment of the present invention;

FIG. 9 is a flowchart illustrating the process for a provider managing its corporate profile according to an embodiment of the present invention;

FIG. 10 is a flowchart illustrating provider interaction with community issues according to an embodiment of the present invention; and

FIG. 11 is a flowchart illustrating the consumer voting process according to an embodiment of the present invention.

In describing the preferred embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION OF THE PREFERRED EMBODIMENTS

The various features and advantageous details of the subject matter disclosed herein are explained more fully with reference to the non-limiting embodiments described in detail in the following description.

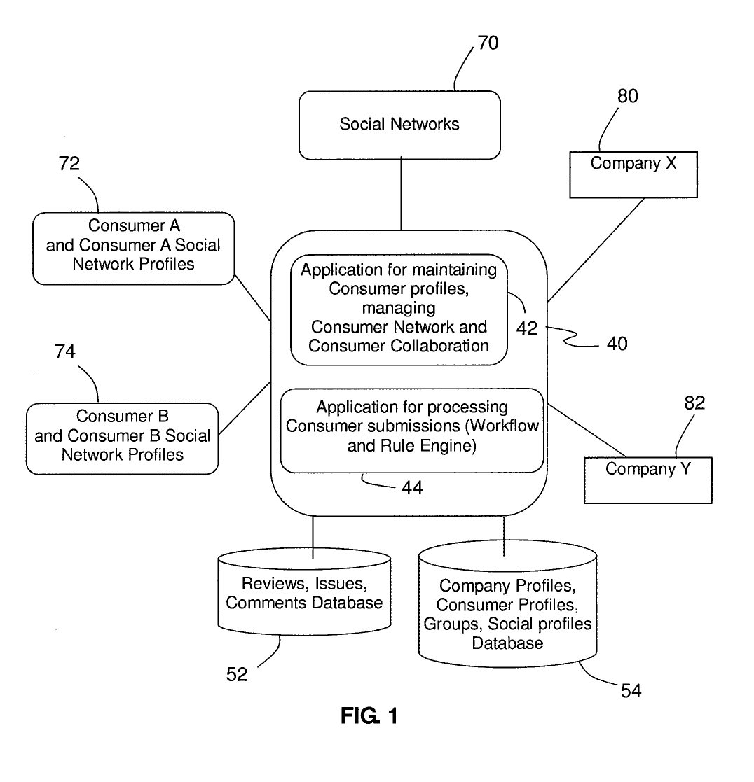

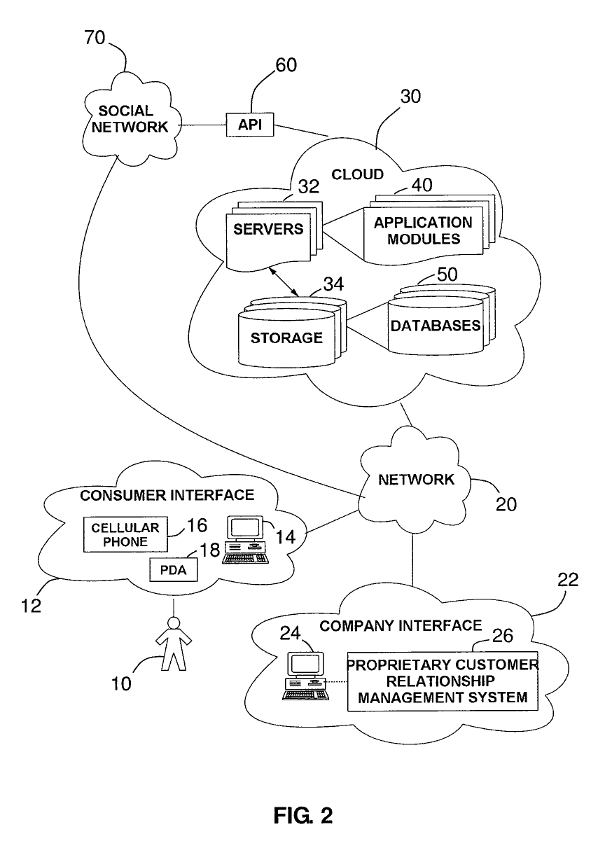

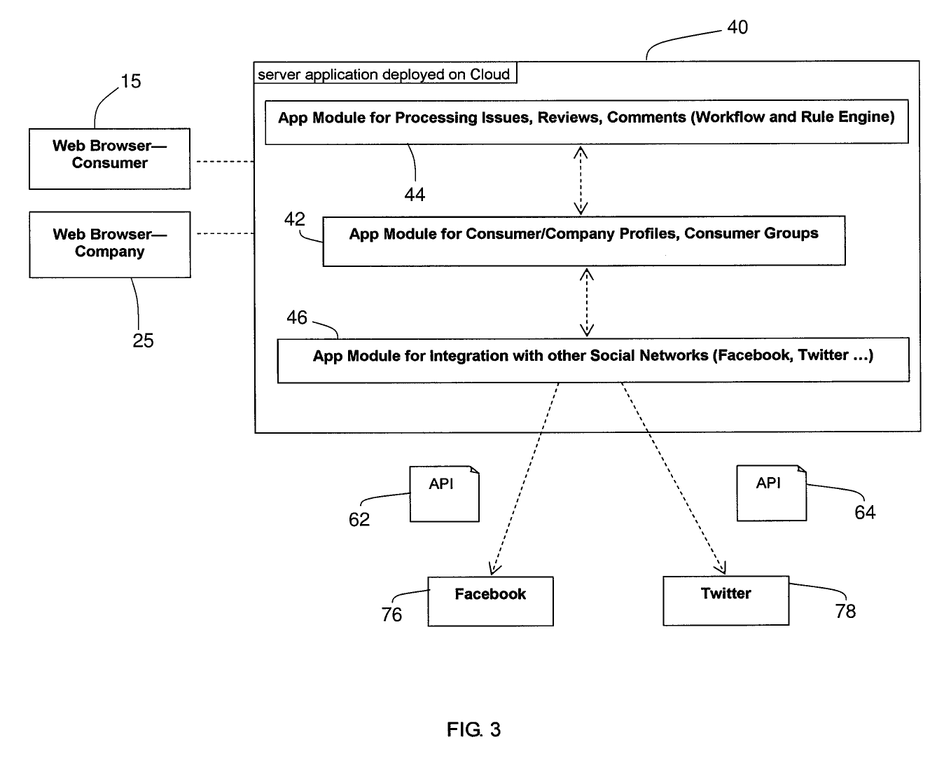

Turning initially to FIGS. 1 and 2, a block diagram representation of a first embodiment of a Customer Relationship Management (CRM) system and an exemplary environment incorporating the CRM system are illustrated. A consumer 10 may access the CRM system through any interface 12 available to the consumer 10. The interface 12 may be, but is not limited to, a computer 14, a cellular phone 16, or a Personal Digital Assistant (PDA) 18. The consumer interface 12 preferably is network-enabled and has access to a network 20, such as the Internet.

Similarly, a provider, or a representative thereof, may access the CRM system through any interface 22 available to the provider. The provider may be a for-profit or not-for-profit purveyor of goods or services, a university or other educator, a government department or agency, or any other institution with which a consumer interacts. Typically, a customer service representative will have a network-enabled computer 24 with access to the network 20, such as the Internet. Optionally, other devices, such as a cellular phone, PDA, text pager, network terminal, etc. may be used to access the network 20. The provider may have an existing proprietary CRM system 26 and/or may choose to operate a separate proprietary CRM system 26 in parallel to the CRM system as disclosed herein.

Referring to FIG. 2, the CRM system preferably is deployed on a computer cloud 30. A “computer cloud” as used herein is a cluster of resources, such as servers 32 and storage media 34, and preferably but not necessarily are independently maintained and operated. The cloud 30 may exist on a single server 32 or, optionally, may be spread over many servers 32 at many locations and linked to one another by an appropriate network, such as the Internet. A server may be a single computer or multiple computers such as desktops or rack-mounted equipment. The servers may be contained in a single room or in multiple locations and are connected to one another by an appropriate internal or external network. The servers include processors for executing application modules and physical storage media to store data. The physical storage media may be of any type known in the art, including but not limited to hard drives, compact discs (CDs) digital video discs (DVDs), non-volatile flash memory, magnetic tapes, or any other suitable storage media. Advantages provided by launching the CRM system on a computer cloud 30 include dynamic scalability of resources such that the CRM system only uses the processing capabilities and storage space required by the application. The cloud 30 typically includes or has access to a significantly greater number of resources than required by an application executing on the cloud 30. The CRM system provider typically is charged based on the number of resources within the cloud 30 used by the CRM system. Optionally, a CRM system provider may maintain a dedicated facility which includes one or more servers 32 and storage media 34 dedicated to executing the CRM system.

The CRM system preferably includes multiple application modules 40 and multiple databases 50 operating on the cloud 30. Each application module 40 includes instructions executable by one or by multiple processors of the servers. The databases 50 provide relational storage for quick access to data and may be stored on a single storage medium or across multiple storage media connected to the servers. For example, the CRM system may include a first module 42 for maintaining consumer profiles, managing consumer networks, and for enabling consumer collaboration. A second module 44 may be used for processing consumer issues, reviews, and comments according to predetermined workflows and rules. A third module 46 may be used for integrating consumers' or providers' existing social profiles with the CRM system and facilitating collaboration on a case with their existing social networks 70. A first database 52 may be used to store submissions from the consumers, providers, or anyone in the community. The submissions may include, but are not limited to, issues, reviews, comments, requests, questions, suggestions, ideas, and responses to any of the preceding items. A second database 54 may be used to store provider profiles, consumer profiles, and social profiles. Still other modules 40 and databases 50, not shown, may be included to perform functions or store data as required by the CRM system. Optionally, the application modules 40 and databases 50 may be structured according to any suitable division or combination of features and/or data as known to one skilled in the art. Alternately, the CRM system may be implemented using a single application module 40 and/or a single database 50.

The consumer 10 may access the CRM system directly through the network 20 using a web browser 15 executed on any suitable consumer interface 12. Optionally, the consumer 10 may first access a social network 70, for example, Facebook 76 or Twitter 78, to which the consumer 10 is a member. At least one application module 40 may be executing within the social network 70 to provide a link to the CRM system. An application module 40 may similarly be deployed in other applications, such as a web advertisement or as a link running on a provider's webpage to provide a link to the CRM system. Using a single sign-on module, the authentication credentials, such as a username and password, provided by the consumer 10 to access the social network 70 will additionally permit access to the CRM system without reentering the username and password. Similarly, the single sign-on module permits consumers 10 to first access the CRM system with authentication credentials and then access their social networks 70. An Application Programming Interface (API), 62 or 64, available for that social network 70 permits interaction between the CRM system and the social network 70. Such interaction may include maintaining or updating social network information on either the social network or the CRM system and transferring data to the other network or system.

Similarly, a provider, or a representative thereof, may access the CRM system directly through the network 20 using a web browser 25 executing on any suitable provider interface 22. Optionally, the provider may first access a social network 70 on which it maintains a presence. Using a single sign-on module, the authentication credentials, such as a username and password, provided by the provider to access the social network 70 will additionally permit access to the CRM system without reentering the username and password. The single sign-on module also permits providers to first access the CRM system with authentication credentials and to subsequently access the social networks 70. An API, 62 or 64, available for that social network 70 permits interaction between the CRM system and the social network 70. Such interaction may include maintaining or updating social network information on either the social network 70 or the CRM system and transferring the data to the other network or system. The provider may also integrate a proprietary CRM system 26 with the CRM system deployed on the cloud 30.

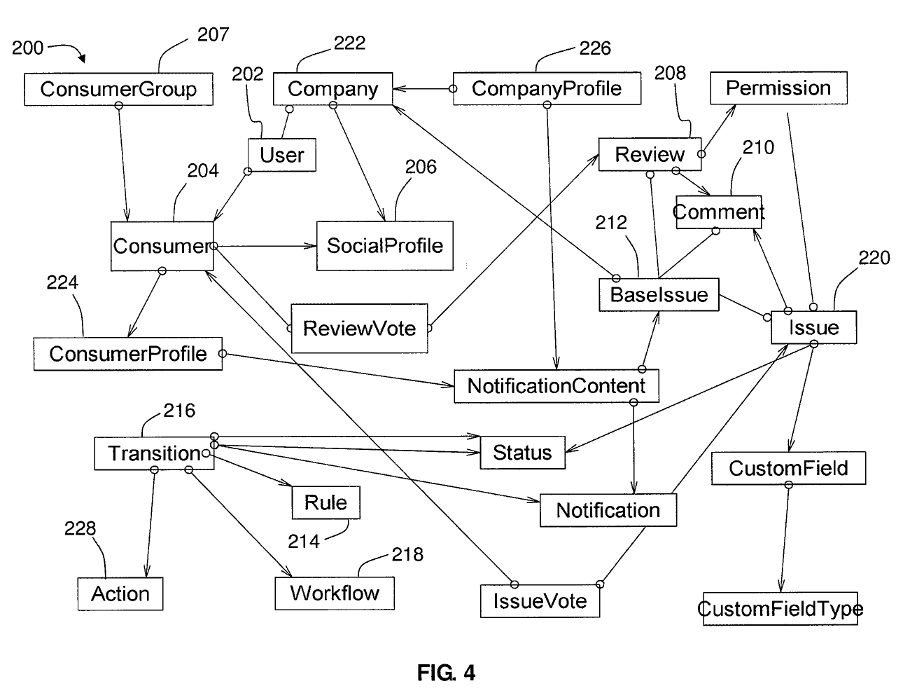

In operation, the CRM system provides a consumer-driven interactive interface for reporting information to and interfacing with providers. Referring to FIG. 4-11, an exemplary database structure 200 and flow diagrams of processes for implementing the CRM system are illustrated.

A consumer 10 first establishes a user account on the CRM system. An application module 40 maintains a database 50 including, for example, a user table 202 which assigns a user ID to each account and stores the user name and password associated with the account. The consumer 10 is required to enter the user name and password to provide secure access to the CRM system. Optionally, a single password or multiple passwords may be used to permit varying levels of security and access to information on the CRM system. The consumer 10 may enter personal identifying information (e.g. name, gender, birth date, and location) stored in a consumer information table 204. The consumer 10 may further identify social networks 70 to which the consumer 10 belongs. The application modules 40 further maintain a table of social profiles 206 and, if the consumer 10 grants permission, may access the consumers' 10 social network pages to retrieve additional consumer information according to access and permission levels established by the consumer 10. The consumer 10 may additionally join or form a consumer group. Members of the consumer group can share ideas, submissions, and create events. The CRM system preferably includes a consumer group table 208 which identifies all groups to which each consumer 10 belongs. Preferably, the consumer 10 determines how much information to provide and for what purpose the information will be used.

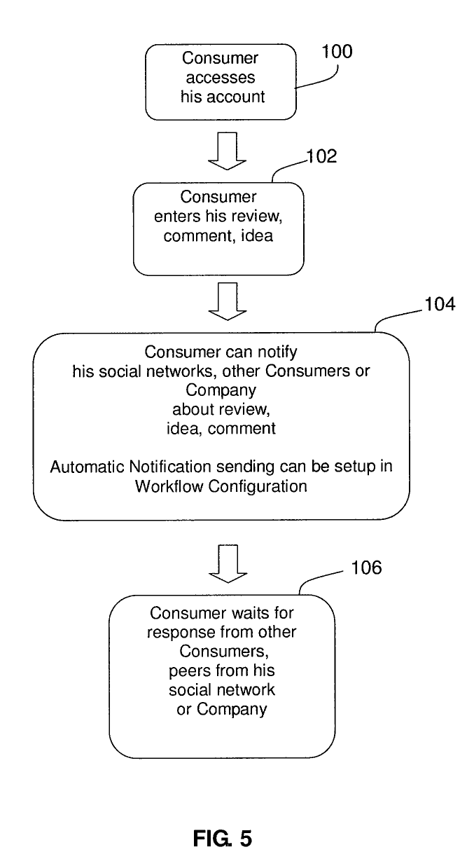

Referring to FIG. 5, the consumer 10 may use the account to provide a submission, such as a comment, a review, a request, or an idea relating to a provider using a procedure identified generally by blocks 100-106. A “block” is used herein to conceptualize a portion of the processes illustrated in the flowcharts. A block may include a single step or multiple steps and may be completed by a single person or device or multiple people or devices at a single location or multiple locations. Further, the flowcharts present exemplary embodiments and are not meant to be limiting. Other embodiments of the present invention contemplate that the steps may be rearranged in varying orders and among varying processes.

In block 100, consumers 10 first access their account on the CRM system. A consumer 10 then enters the submission at block 102. An application module 40 stores each of the submissions in a database 50. Each of the submissions may be stored in a single element of the database, such as a record, a table, or a file or, optionally, the submissions may be sorted by, for example, the type of information submitted into separate elements of the database, such as a review table 208 or a comment table 210. For ease of searching, the CRM system preferably requires the consumer to identify a base issue to which the submission relates. The base issue identifies, for example, a general concept, service, or product, to which any submission may be related. The base issue can link comments, reviews, issues, or other submissions by multiple consumers and may be stored in a separate table 212 for quick access, sorting, and searching. In block 104, the consumer 10 may then notify others in his social networks, consumer groups, or the provider to which the posting relates. Optionally, the consumer 10 may establish a rule to automatically notify one or more of these groups. “Rules” as used herein are sequences that are executed based on the occurrence of an event.

An application module 40 monitors events, such as a consumer submission, and determines if a rule needs to be executed. The application module 40 preferably interfaces with the rule table 214, a state machine 216, and a workflow table 218 to determine what actions to take based on the event. A state machine 216 defines different states, or operating conditions, in which a submission or case may exist. For example, a submission may be a general comment for review by the community, or may be a request for information awaiting a response from a provider. The application module 40 uses rules in the rule table 214 to put the case into an appropriate state, such as notifying a provider or requesting comment from the community. Similarly, the workflow table 218 may define a series of steps that direct the case through a series of states. An exemplary series of states may include, but is not limited to, waiting for submission of a case from a consumer, notifying a provider of the case, waiting for a response from the provider, notifying the consumer of the response, waiting to close the close, and closing the case in response to an acceptable resolution. As a rule or a workflow process requests different states, the state machine 216 defines a set of desired operating parameters for the case during each state. The operating parameters may include, for example, what action is to be performed and by whom the action is expected to be performed. After posting a submission, the consumer 10 awaits responses from other consumers 10, peers from his social networks, or the provider in block 106.

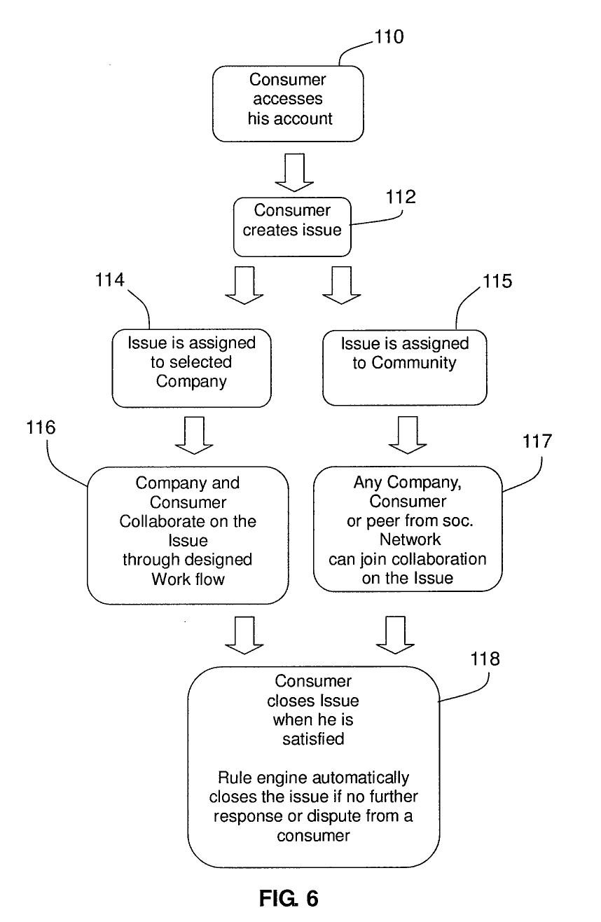

In addition to posting a comment or review, the consumer 10 may further use the CRM system to initiate a customer service-related action pertaining to a service or product received from a provider. In this case, referring to blocks 110-118 in FIG. 6, the consumer 10 accesses his account at block 110. The consumer 10 creates a new case identifying the issue and the provider involved at block 112. The issue may, for example, describe a dispute between the consumer 10 and the provider or may also describe a service request, a warranty repair request, a billing clarification request, or any other request for information from the provider by the consumer. Optionally, the issue may be a generalized problem experienced by the consumer 10 and not directed toward a specific provider. A generalized problem typically applies to products or services available from many providers such that any provider or other consumer who has experienced the problem may be able to provide a solution and may be, for example, incompatible video formats between a television and a video playback device or problems with insects or disease in landscaping. Each new issue may be stored in an issue table 220 and include data such as the consumer's name, date of incident, description and current status of issue, proposed resolution, community comments, and voting status. The CRM system preferably requires the consumer 10 to identify a base issue to which the issue relates for inclusion in an issue table 212. Optionally, the consumer 10 may select from a list of base issues already included in the issue table 212 to identify a prior submission to which the new problem relates or is similar. Optionally, the consumer 10 may access the CRM through a social network 70 to which the consumer belongs.

A significance factor may be included as a field in, for example, the review table 208, the comment table 210 or the issue table 220 in order to rate the importance of a submission relative to other submissions. The significance factor may be calculated by the number of votes on a submission, as described below, by the number of times the submission was viewed, or by using a set of rules predefined by the consumer 10 or the provider. The significance factor may similarly be increased by the number of comments by other consumers 10 or by the number of other submissions having the same or a related base issue. The significance factor may be used to order search results when searching for submissions pertaining to a specific product or provider.

The new case is assigned to the provider against which the consumer 10 has an issue in block 114 and/or assigned to the community in general if the issue is a generalized problem in block 115. If the issue is assigned to the general community, any provider or other consumer 10 that is a member of the CRM system or a peer from the original consumer's social network that has been notified of the issue may collaborate 117 to suggest a solution to the issue. If the issue is assigned to a specific provider, the CRM system will attempt to notify the provider of the new issue. For providers that are members of the CRM system, the case will be delivered to the contact identified in the company table 222 of the database. If a provider is not a member, an application module 40 of the CRM system will attempt to identify a customer service contact for that provider, such as an email address or a provider's proprietary CRM website, and forward the issue to the identified contact. The application module 40 may execute a rule to search a network, such as the Internet, for the desired contact information. Optionally, the application module 40 may search a table or other database that includes a precompiled list of contact information for different providers.

The consumer 10 and the provider will attempt to resolve the issue at block 116. Once the issue has been resolved to the satisfaction of the consumer 10, the consumer 10 can then close the issue at block 118. However, consumers 10 may not always follow through and close issues after receiving a satisfactory resolution. Consequently, at block 118 a rule stored in the rule table 214 of the CRM system will cause the issue to be closed automatically after a predetermined time has elapsed from the consumer receiving a response to the issue on the assumption that the consumer is satisfied. Further, a consumer 10 may not be satisfied with the proposed resolution from the provider and may keep the case active after receiving the proposed resolution. In order to bring such a case to resolution, at block 118 another rule from the rule table 214 may be invoked in which the CRM system initiates a community vote on the proposed resolution. The voting process will be described in more detail below.

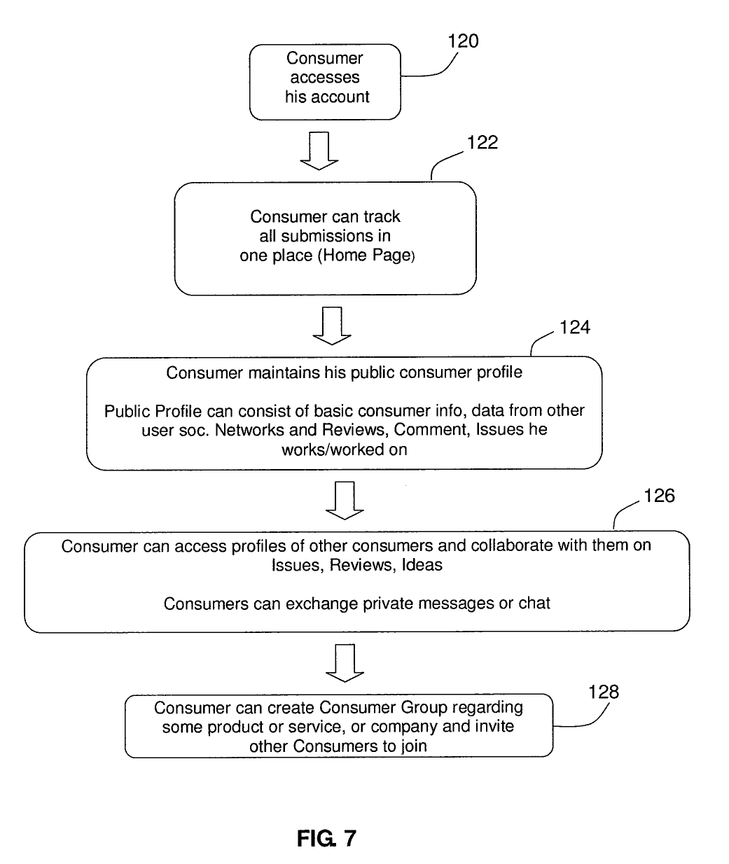

The CRM system itself may perform many functions similar to a social network. Referring to blocks 120-128 in FIG. 7, a consumer 10 may access his account in block 120 to perform functions in addition to posting a review, comment, or issue as previously described. At block 122, the consumer 10 can track all previous postings from a single location. The consumer 10 may update the information in the consumer's public profile, in block 124. This information may include, but is not limited to, the personal identifying information previously entered into the consumer information table 204, previously posted submissions that may be stored in a consumer profile table 224, or the links to the consumer's social networks in the social profile table 206. The consumer 10 may also access the public profiles of other consumers 10 on the CRM system at bock 126. The consumer 10 may choose to collaborate with another consumer 10 on issues or ideas posted by the other consumer 10. At block 128, the consumer 10 may also choose to form a consumer group which may include other consumers 10 and may be used to focus attention on a specific provider or issue.

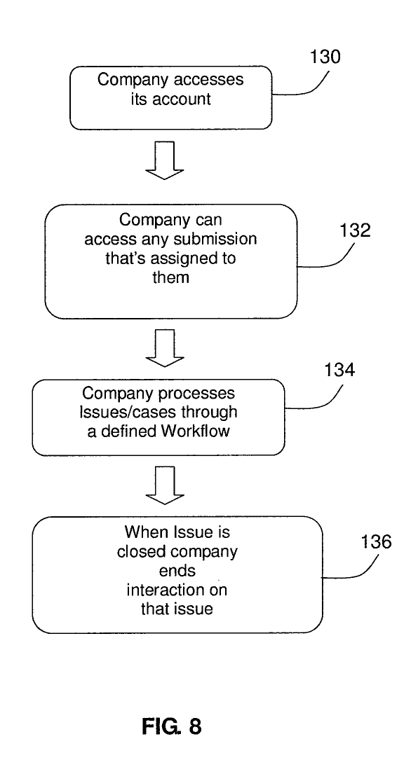

A provider primarily uses the CRM system to resolve issues assigned to that provider. Referring to blocks 130-136 in FIG. 8, the provider accesses its account at block 130 and may then access any submission that has been assigned to that provider at block 132. The provider processes the submissions through a defined workflow process in block 134. The workflow process may be defined in the workflow table 218 of the CRM system or, optionally, each provider may have a proprietary CRM system 26 to direct the resolution process. The proprietary CRM system 26 may interface directly with the CRM system using a publicly available API in order to retrieve information relating to a submission or the provider may manually enter information into the proprietary CRM system 26. The provider continues to interact with the consumer 10 until the case is closed at block 136.

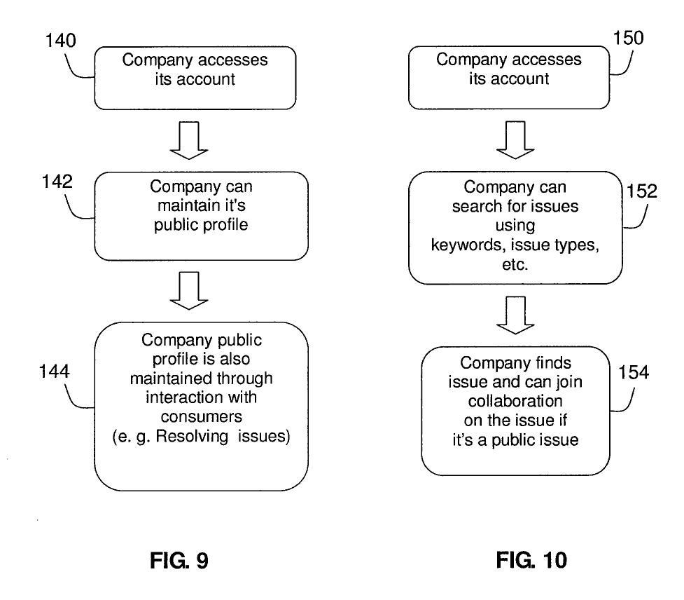

Referring to FIGS. 9 and 10, a provider may further choose to interact with the network established by the CRM system. After accessing its account in block 140 or 150, the provider may update, at least in part, the information in its public profile at block 142. The information in the provider's public profile may include, but is not limited to, contact information provided in the company table 222 and information in a company profile table 226, which is generated by consumers 10 and the CRM system, such as submissions, and a provider rating. The provider may directly modify the information in the company table 222 at block 142 but, as shown in block 144, the provider's interaction with consumers also influences the information maintained in the company profile table 226. The provider may further interact with the community at block 152 by searching for keywords in submissions not assigned to that provider and by participating in the resolution or collaboration on a general submission in block 154.

An application module 40 executing on the CRM system determines rankings for each of the providers discussed on the CRM system. The rankings provide the general community with an indicator of how well the provider interacts with consumers. The rankings may be based, for example, on the consumer reviews, comments, number of open issues, number of resolved issues, number of issues satisfactorily resolved, and the number of general issues on which the provider collaborates with the community to resolve.

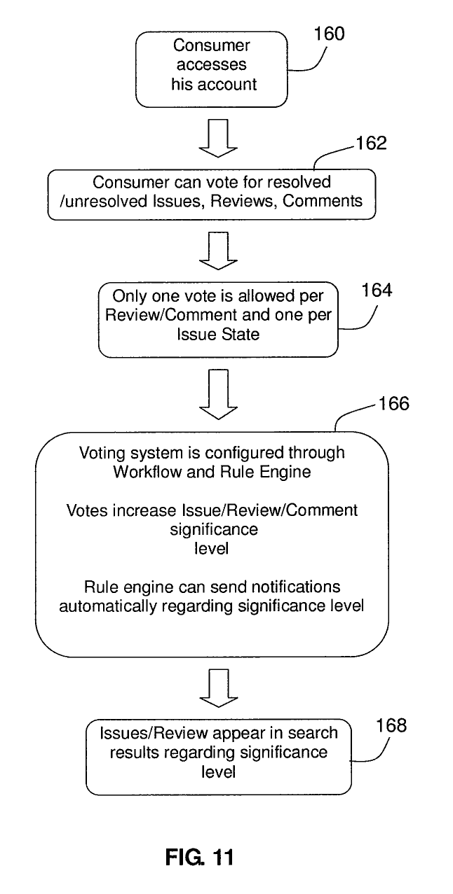

An application module 40 executing on the CRM system may control voting on cases that remain unresolved despite attempts by the provider to provide a solution or on cases that were closed by the consumer 10 but were not resolved in a manner that entirely satisfied the consumer 10. Referring to FIG. 11, consumers 10 access their accounts at block 160 and are presented with an option to vote for specific cases in block 162. The consumers 10 selected to vote may include those pertaining to a specific consumer group, those with related cases, or even the entire community. Voting may be necessary in those instances when a consumer 10 is so dissatisfied with a service or product that no solution offered by the provider will be satisfactory to the consumer 10. Conversely, a provider may be unwilling to provide a solution that would be considered satisfactory to a majority of consumers 10. In either instance, the case remains open and adversely affects the ranking of the provider. Consequently, the voting system permits the community to decide whether the provider has worked with the consumer to fairly resolve the case.

The voting system is controlled by the rules and workflow engine defined by the tables, 214 and 218, in the CRM system. Only one vote is allowed per consumer 10 per state of a comment or issue as indicated in block 164. For instance, after an initial vote, a provider may propose a revised solution to an issue presenting a new state on which the consumers 10 may vote. The significance factor may be increased by a vote, or by the number of votes, on the issue or comment at block 166. The significance factor may be used to order search results when a consumer or provider searches for reviews or issues pertaining to a specific product or provider as shown in block 168. After the period for voting has elapsed, the CRM system may cause a case to be closed if the community votes in favor of the provider. Consequently, if the general community feels that a proposed solution is fair while the consumer 10 involved does not, the case will be closed to prevent further negative influence on the provider's rating.

The CRM system additionally includes at least one application module 40 executing to monitor events occurring in the system. The application module 40 preferably interfaces with tables defining rules 214, workflow 218, transitions or states 216, and actions 228. The CRM system may keep the general community, as well as specific consumers 10 or providers, informed of events in the system. For example, if a new submission is posted, the system may provide notification to all other consumers having a related submission or to all providers of similar goods and/or services. Similarly, if a new comment is posted on an existing submission, all consumers having a related submission or comment may receive notification of the new comment.

The CRM system proposed herein provides advantages to both consumers and providers. It permits the consumer 10 to initiate cases against providers with which it has an issue. It further allows the consumer 10 to keep the case open until a successful resolution has been reached or voted upon. The CRM system provides a uniform interface for the consumer 10 regardless of the provider with which the dispute arose. Further, the consumer 10 may access the CRM system via links from existing social networks. Providers do not need to purchase or maintain a proprietary CRM system. Additionally, providers that provide quick resolution to issues and comments enjoy a favorable ranking readily accessible to members of the community.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

We claim:

1. A network-based customer relationship system for managing data exchanged between a plurality of consumers and a plurality of providers, comprising:
a consumer interface configured to receive data from at least one of the consumers, the data including a field to identify one of the providers; and
an application module in communication with the consumer interface and executable on a processor to establish a case corresponding to the data entered by the consumer, extract from the data the field identifying the provider, and notify the provider of the existence of the case, wherein the case is accessible to at least one other consumer.

2. The network-based customer relationship system of claim 1, wherein the application module is further executable to communicate on a network to establish an interactive environment accessible by the consumers and the providers.

3. The network-based customer relationship system of claim 2, wherein the application module is further executable to access a data storage device on which each of the consumers and providers establish an account for the interactive environment, the account requiring user verification to access.

4. The network-based customer relationship system of claim 3, further comprising an Application Programming Interface (API) in communication with the application module that interfaces with another network-based environment.

5. The network-based customer relationship system of claim 4, wherein the account of the consumers or providers for the interactive environment includes information about a respective account for the consumer or provider on the other network-based environment and wherein the API uses the information to permit access to the interactive environment from the other network-based environment without additional user verification.

6. The network-based customer relationship system of claim 2, wherein the application module is further executable to establish a plurality of groups to which one or more consumers or providers are members.

7. The network-based customer relationship system of claim 6, wherein the groups are established according to the content of the cases and wherein the application module is further executable to notify each member of the group when a new case is established which contains the respective content.

8. The network-based customer relationship system of claim 2, wherein the application module is further executable to manage a scoring system ranking each of the providers as a function of the number of cases in which that provider is identified.

9. The network-based customer relationship system of claim 8, wherein the provider responds to each case in which the provider is identified and the ranking of each of the providers is a function of the response.

10. The network-based customer relationship system of claim 9, wherein the application module is further executable to manage a voting system which receives votes from a plurality of other consumers to resolve cases.

11. The network-based customer relationship system of claim 2, further comprising a provider interface that is in communication with the application module and that is configured to receive case data from the application module and to send data to the application module responsive to the case data.

12. The network-based customer relationship system of claim 2, wherein the data entered by the consumer is accessible to at least one other provider not identified by the field in the data and wherein the other provider may submit a response to the data.

13. A method of managing a customer relationship system, comprising the steps of:
executing at least one application module on a server to provide an interactive environment for a plurality of consumers an at least one provider to provide information to each other;
receiving information relating to at least one provider through a consumer interface;
creating a case corresponding to the information received from each consumer using the application module;
storing the case and the related information in a database on a physical storage medium connected to the server;
sending a notification from the application module to each provider identified in the case that the case has been established; and
making the case available on the server for access by a plurality of other consumers.

14. The method of managing a customer relationship system of claim 13, further comprising the steps of:
receiving a response at the application module from each provider relating to the case through a provider interface in communication with the application module;
storing the response from the provider in the database on the physical storage medium connected to the server;
sending a notification from the application module to the consumer of the response; and
making the response available on the server for access by the plurality of other consumers.

15. The method of managing a customer relationship system of claim 14, further comprising the step of resolving the case by one of the following steps:
closing the case by receiving an acceptance of the response from the consumer through the customer interface;
automatically closing the case with the application module at a predefined time interval after receiving the response from the provider; and
establishing a voting system with the application module to receive votes on the acceptability of the response from the provider by a plurality of consumers.

16. The method of managing a customer relationship system of claim 14, further comprising the step of maintaining a rating system in the application module to rate the provider according to at least one of a time required for response, a total number of cases reported to the provider, and a level of consumer satisfaction with the responses received from the provider.

17. The method of managing a customer relationship system of claim 13, wherein the application module may execute to establish a plurality of groups of consumers, further comprising the step of generating a notification in the application module notifying at least one the groups of the new case according to the information relating to the case.

18. The method of managing a customer relationship system of claim 17, wherein the application module executes to request feedback from the consumers belonging to the group notified of the new case.

19. A customer relationship system comprising:
means, executing on a server, for providing an interactive environment for a plurality of consumers and providers to provide information to each other;
means for receiving information from a plurality of consumers relating to at least one provider;
means for creating a case corresponding to the information from the consumer;
at least one physical storage medium connected to the server and storing the case and the related information in a database; and
means for notifying each provider that the case has been established.
